(19) United States
(12) Patent Application Publication
(10) Pub. No.: US 2024/0240638 A1
(43) Pub. Date: Jul. 18, 2024

(54) REFRIGERANT COMPRESSOR

(71) Applicant: Hanon Systems, Daejeon (KR)

(72) Inventors: Christian Sett, Viersen (DE); Thomas Klotten, Köln (DE)

(21) Appl. No.: 18/549,776

(22) PCT Filed: Oct. 4, 2022
(86) PCT No.: PCT/KR2022/014869

§ 371 Date: Sep. 8, 2023

(30) Foreign Application Priority Data
Oct. 10, 2021 (DE) 10 2021 126 248.8

(51) Int. Cl. F04C 29/00; F16C 35/067

(52) U.S. Cl. CPC F04C 29/005; F16C 35/067; F04C 2240/50

(57) ABSTRACT

A refrigerant compressor including a compressor housing, a drive shaft for driving a compression mechanism, which is arranged within the compressor housing, a main bearing via which the drive shaft is supported on the compressor housing and which includes an inner ring fixed to the drive shaft and an outer ring pressed into the compressor housing, wherein protruding tooth-like protrusions which press into an adjacent wall of the compressor housing are arranged on an end face of the outer ring in the direction of the ring axis of the outer ring. This is sufficient to prevent rotation of the outer ring even when there is no longer a press fit in the radial direction between the outer ring of the bearing and the compressor housing.

### CROSS REFERENCE TO RELATED PATENT APPLICATIONS

This is a U.S. national phase patent application of PCT/KR2022/014869 filed Oct. 4, 2022 which claims the benefit of and priority to German Patent Application No. 10 2021 126 248.8 filed on Oct. 10, 2021, the entire contents of each of which are incorporated herein by reference.

### TECHNICAL FIELD

The invention relates to a refrigerant compressor, in particular an electrical refrigerant compressor for a motor vehicle air-conditioning system.

### BACKGROUND ART

In electrical refrigerant compressors, a shaft is used to drive a compression mechanism such as the mechanism of a scroll compressor, wherein both the shaft and the other components necessary for the compression mechanism are arranged inside a compressor housing. To guide the shaft and to ensure operation which is as wear-free as possible, the shaft is supported by a main bearing, in most cases a ball bearing. The main bearing has an outer ring which is press-fitted in the compressor housing. This press fit ensures that the outer ring cannot rotate. Owing to the different coefficients of thermal expansion of the compressor housing, which generally consists of aluminum, and of the outer ring of the main bearing, which generally consists of steel, the press fit between the two components is reduced with increasing temperature during operation and can even cease almost completely. The reduction in the press fit can lead to the main bearing rotating and wear arising in the compressor housing, as a result of which the refrigerant compressor can be damaged. A rotating outer ring in conjunction with high axial forces acts like a milling tool.

To prevent rotation of a bearing even in the case of a temperature increase, different solutions are proposed in the prior art. So-called thermal compensation bearings, for example made by SBN Walzlager GmbH & Co. KG, are known, in which grooves are milled into the outer ring of the bearing. Plastic rings are inserted into these grooves. These plastic rings have the same or a higher coefficient of thermal expansion than the aluminum housing. This ensures sufficiently high press-fitting even at higher temperatures. The disadvantage of such a solution is that multiple additional process steps are necessary to manufacture the thermal compensation bearing. Firstly, the outer ring of the bearing must be machined to produce the grooves. Additionally, the plastic rings must be manufactured using an injection molding method and introduced into the grooves. This makes manufacture complex and contributes correspondingly to increased costs therefor.

JPH0984293 A discloses a further solution. In this case, the outer ring of a ball bearing is designed with four protrusions on the rear surface, each of these protrusions extending in the direction of the axis of the ball bearing. Furthermore, four holes are formed in each case in the rear wall of the bearing housing, the washer or the flat disc, each protrusion of the ball bearing fitting into a hole in the flat disc and in the shaft. The protrusion is inserted through the hole in the washer into the hole in the bearing housing. According to this solution, the outer ring is prevented from rotating by fitting each protrusion of the ball bearing into the hole in the bearing housing. Since there is no rubber ring attached to the outer circumferential face of the ball bearing, the ball bearing can also be installed in the bearing housing easily. However, in such a solution, additional components such as a bearing housing, a washer and a spring are needed, which likewise causes considerable complexity and additional costs. Components must be positioned correctly in order to interlock, which makes assembly more difficult. The provision of a bearing housing also reduces the possible installation space for the bearing.

The object of the invention consists in securing the main bearing for driving the compression mechanism in an electrical refrigerant compressor against rotation and thus reducing wear in the compressor housing of the refrigerant compressor.

### SUMMARY

The object of the invention is achieved by a refrigerant compressor, preferably an electrical refrigerant compressor, having the features as shown and described herein.

The refrigerant compressor comprises
a compressor housing
a drive shaft for driving a compression mechanism, which is arranged within the compressor housing,
a main bearing via which the drive shaft is supported on the compressor housing and which comprises an inner ring fixed to the drive shaft and an outer ring pressed into the compressor housing, wherein protruding tooth-like protrusions which press into an adjacent wall of the compressor housing are arranged on an end face of the outer ring in the direction of the ring axis of the outer ring.

According to the concept, the outer ring is secured to prevent the bearing rotating as temperatures rise. Tooth-like protrusions, also referred to below as teeth, are additionally attached to the outer ring of the main bearing in the axial direction. These press into the compressor housing when the main bearing is pressed in. This is sufficient to prevent rotation of the outer ring even when there is no longer a press fit in the radial direction between the outer ring of the bearing and the housing.

The pressing-in force can be selected such that the tooth elements plastically deform the material of the compressor housing. These plastic deformations in the compressor housing can have the same shape as the tooth elements of the main bearing, which would result in a form-fit connection between these two components. Preferably, there is a form-fit connection between the main bearing and the compressor housing. The securing against rotation of the outer ring of the main bearing is thus independent of temperatures and the different press fits resulting therefrom.

According to an advantageous embodiment of the invention, the tooth-like protrusions respectively extend individually in the radial direction over the complete width of the end face. Preferably, the tooth-like protrusions are arranged uniformly distributed in the circumferential direction over the complete circumference of the outer ring.

In contrast to the thermal compensation bearing described above, the outer ring of the axially toothed main bearing can be manufactured in one piece and is also advantageously manufactured in this way. This means that the outer ring is preferably formed integrally. In a thermal compensation bearing, the grooves must be milled into the outer ring. The plastic rings must then be inserted into the grooves. These additional work steps are not necessary in the main bearing used according to the invention, the outer ring of which is provided with axially protruding tooth elements, since the manufacture of the teeth can be part of the forging process for manufacturing the outer ring. For this, the forging tool of the outer ring can be designed such that the teeth are already produced in the forging process. As a result, no further machining steps are necessary. No additional components are needed either.

Preferably, the refrigerant compressor is a scroll compressor. A scroll compressor, also referred to as a spiral compressor, comprises as components for the compression mechanism two interleaving spirals inside the compressor housing, one spiral being stationary, and the other spiral being movable eccentrically as an orbiting spiral on a circular trajectory, and the volume of compression chambers formed between the spirals can be changed cyclically by the movement of the spiral. In the scroll compressor, the drive shaft drives the orbiting spiral.

To ensure long-term operational safety, the main bearing must be protected from axial movement during operation, otherwise the security against rotation of the outer ring cannot be guaranteed. Owing to the counterpressure in a scroll compressor, the axial forces are always between 300 N and 910 N, which ensures a sufficiently high pressing force at all times. The security against rotation of the outer ring of the main bearing and the operational safety can thus be improved.

Preferably, the main bearing is a rolling bearing; particularly preferably, a ball bearing is used.

Further details, features and advantages of embodiments of the invention can be found in the description of exemplary embodiments below with reference to the associated drawings.

### BRIEF DESCRIPTION OF DRAWINGS

In the drawings:

FIG. 1: shows a thermal compensation bearing, prior art,

FIG. 2: shows a sectional diagram of a portion of an electrical refrigerant compressor in the region of the main bearing of the shaft for driving the compression mechanism,

FIG. 3A: shows a perspective diagram of the outer ring of the main bearing,

FIG. 3B: shows a view of a section of the outer ring of the main bearing towards the ball race thereof, and

FIG. 4: shows a schematic diagram of the finishing of the outer ring, starting from a cast blank after casting.

### DESCRIPTION OF AN EMBODIMENT

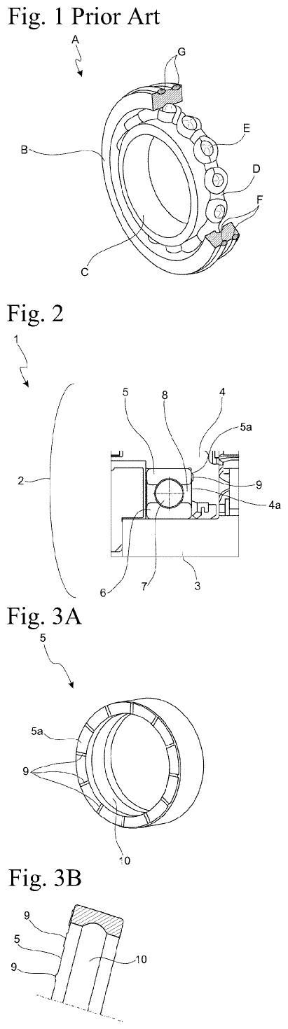

FIG. 1 shows a ball bearing A according to the prior art, which is designed as a thermal compensation bearing in order to prevent rotation of a bearing even in the case of a temperature increase. The ball bearing A comprises an outer ring B, an inner ring C, and a likewise annular bearing cage D, which is arranged in the radial direction between the outer ring B and the inner ring C and into which, distributed over the circumference of the bearing cage, balls E are inserted as rolling elements and are spaced from one another in order to reduce the frictional resistance. The ball bearing shown in FIG. 1 is a thermal compensation bearing as offered for example by SBN Walzlager GmbH & Co. KG, in which grooves F are milled into the outer ring B of the bearing. Plastic rings G are inserted into these grooves F. These plastic rings G have the same or a higher coefficient of thermal expansion than a compressor housing (not shown in FIG. 1), which consists of aluminum. The higher thermal coefficient of the plastic rings G ensures sufficiently high press-fitting even at higher temperatures. The disadvantage of such a solution is that multiple additional process steps are necessary to manufacture the thermal compensation bearing. Firstly, the outer ring B of the ball bearing A must be machined to produce the grooves F. Additionally, the plastic rings G must be manufactured using an injection molding method and introduced into the grooves F.

FIG. 2 shows a sectional diagram of a portion 1 of an electrical refrigerant compressor in which the main bearing 2 of a shaft 3, referred to below as drive shaft 3, is situated. In electrical refrigerant compressors, the drive shaft 3 is used to drive a compression mechanism, for example to drive the mechanism of a scroll compressor, wherein both the drive shaft 3 and the other components necessary for the compression mechanism are arranged inside a compressor housing 4. A scroll compressor, also referred to as a spiral compressor, comprises as components for the compression mechanism two interleaving spirals inside the compressor housing 4, one spiral being stationary, and the other spiral being movable eccentrically as an orbiting spiral on a circular trajectory, and the volume of compression chambers formed between the spirals can be changed cyclically by the movement of the spiral. In the scroll compressor, the drive shaft 3 drives the orbiting spiral.

To guide the drive shaft 3 and to ensure operation which is as wear-free as possible, the drive shaft is supported by the main bearing 2. The main bearing 2 has an outer ring 5 which is press-fitted in the compressor housing 4. This press fit ensures that the outer ring 5 cannot rotate. In the case shown in FIG. 2, the main bearing is a ball bearing 2 having the outer ring 5, an inner ring 6 which is fixed to the drive shaft 3, and balls 7 as rolling elements 7 arranged between the outer ring 5 and the inner ring 6.

As can be seen in FIG. 2, tooth-like protrusions 9, which are also referred to below as teeth 9, protruding axially, i.e., in the direction of the ring axis 8 of the outer ring 5, are arranged on an end face 5a of the outer ring 5 of the main bearing 2.

FIG. 2 schematically shows how the main bearing with the axially protruding teeth 9 on the outer ring 5 is pressed into the compressor housing 4 such that the teeth 9 press into an adjacent wall 4a of the compressor housing 4. This state is also referred to as axial toothing of the main bearing. The pressing-in force can be selected such that the teeth 9 plastically deform the material of the compressor housing 4. These plastic deformations in the compressor housing 4 have the same shape as the teeth 9 of the outer ring 5 of the main bearing 2. This results in a form-fit connection between these two components, i.e., the main bearing 2 and the compressor housing 4. This is sufficient to prevent rotation even when there is no longer a press fit in the radial direction, in relation to the outer ring 5, between the outer ring of the main bearing and the compressor housing. This means that, owing to the form-fit connection between the main bearing 2 and the compressor housing 4, securing against rotation of the outer ring 5 of the main bearing is independent of temperatures and the different press fits resulting therefrom.

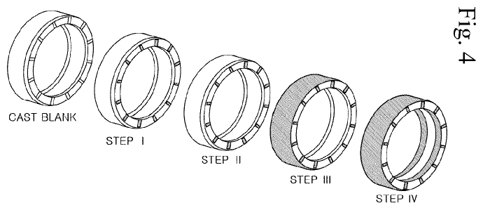

FIG. 3A shows a perspective view of the outer ring 5 of the main bearing towards the circular ring-shaped end face 5a with a plurality of axially protruding teeth 9. The teeth 9, which respectively extend individually in the radial direction over the complete width of the end face 5a, are arranged uniformly distributed in the circumferential direction over the complete circumference of the outer ring 5. In the exemplary embodiment shown in FIG. 3A, the axially protruding teeth 9, of which there are 12 in total, are distributed over the circular ring-shaped end face 5a of the outer ring 5 in the manner of numerals on the face of a clock. On the inside of the outer ring 5, a ball race 10 with a concave cross-section adapted to the ball shape runs over the entire inner circumference of the outer ring 5. FIG. 3B shows a detail view of a section of the outer ring 5 of the main bearing towards the ball race 10 thereof. FIG. 3B also shows the axially protruding teeth 9 of this section. They are approximately 5 times wider in the circumferential direction than their height with which they axially protrude and which is approximately 0.2 mm. The dimensions should preferably be selected such that the pressing-in force is sufficient to deform the housing plastically until the teeth are fully embedded in the housing. In addition, it should be ensured that the plastic deformation remains so small that any influence on further functions and components of the compressor is excluded as far as possible. The use of twelve teeth 9 each having a width of 1 mm and an embedding depth of 0.2 mm has proven particularly advantageous and practicable for the specific application. The exact dimensions can be redefined and evaluated in each case for different applications.

FIG. 4 schematically shows the order in which the outer ring should practically be finished and how the manufacture of the outer ring is simplified thereby. In contrast to the thermal compensation bearing shown in FIG. 1, the outer ring of the axially toothed main bearing can be manufactured in one piece. In a thermal compensation bearing, the grooves must be milled into the outer ring; cf. FIG. 1. The plastic rings must then be inserted into the grooves. These additional work steps are not necessary in the main bearing used according to the invention, the outer ring of which is provided with axially protruding teeth, since the manufacture of the teeth can be part of the forging process for manufacturing the outer ring.

This means that the forging tool of the outer ring can be designed such that the teeth are already produced in the forging process. As a result, no further machining steps other than the machining steps I to IV mentioned below for machining the cast blank are necessary. No additional components are needed either.

First, the front side of the cast blank is post-machined in step I. In step II, the rear side is post-machined. In a subsequent step III, the cast blank is machined correspondingly in the region of the outer diameter. Finally, in step IV, the inner ball race is also subjected to post-machining.

### LIST OF REFERENCE NUMERALS

1 Portion of an electrical refrigerant compressor
2 Main bearing, ball bearing
3 Drive shaft
4 Compressor housing
4a Wall of compressor housing
5 Outer ring
5a End face of outer ring
6 Inner ring
7 Ball, rolling element
8 Ring axis of outer ring
9 Tooth-like protrusions, teeth
10 Ball race of outer ring

1-10. (canceled)

11. A refrigerant compressor, comprising:
a compressor housing; and
a drive shaft for driving a compression mechanism, which is arranged within the compressor housing, a main bearing via which the drive shaft is supported on the compressor housing and which comprises an inner ring fixed to the drive shaft and an outer ring pressed into the compressor housing, wherein protruding tooth-like protrusions which press into an adjacent wall of the compressor housing are arranged on an end face of the outer ring in a direction of a ring axis of the outer ring.

12. The refrigerant compressor according to claim 11, wherein a material of the compressor housing is plastically deformed through the tooth-like protrusions.

13. The refrigerant compressor according to claim 11, wherein there is a form-fit connection between the main bearing and the compressor housing.

14. The refrigerant compressor according to claim 11, wherein the tooth-like protrusions respectively extend individually in a radial direction over a complete width of the end face.

15. The refrigerant compressor according to claim 11, wherein the tooth-like protrusions are arranged uniformly distributed in a circumferential direction over a complete circumference of the outer ring.

16. The refrigerant compressor according to claim 11, wherein the outer ring is manufactured in one piece.

17. The refrigerant compressor according to claim 16, wherein the outer ring is manufactured in the one piece in a forging process.

18. The refrigerant compressor according to claim 17, wherein the tooth-like protrusions are created in a forging process together with the outer ring.

19. The refrigerant compressor according to claim 11, wherein the refrigerant compressor is a scroll compressor.

20. The refrigerant compressor according to claim 11, wherein the main bearing is a ball bearing.
